(19) United States
(12) Patent Application Publication
(10) Pub. No.: US 2009/0158156 A1
(43) Pub. Date: Jun. 18, 2009

(54) Online programming of operator interface panel

(76) Inventors: Vaibhav Vaidya, Atlanta, GA (US); Raymond Husman, Urbana, IA (US); Rajesh K. Tiwari, Carol Stream, IL (US)

Correspondence Address: PYLE & PIONTEK, LLC, 221 N LASALLE STREET , ROOM 1207, CHICAGO, IL, 60601, US

(21) Appl. No.: 10/354,748

(22) Filed: Jan. 30, 2003

(51) Int. Cl. G06F 3/01; G06F 3/041

(52) U.S. Cl. 715/719; 345/173

(57) ABSTRACT

An operator interface panel with means for editing video pages in the panel when the panel is online. This allows a user to work directly with the panel for adding or deleting new video pages, making modifications to the pages by adding or deleting objects, or by making changes to the objects on the pages. The result is time saving for development of video pages. In addition, machine start-up time and diagnosis time is saved because of online programming capability in the panels.

### BACKGROUND

1. Field of Invention

This invention relates to operator interface panel, specifically to a means of programming operator interface panel video pages directly in the operator interface panel without interrupting the function of the panel. This document considers the operator interface panel to be on line when it is performing its intended interface or visualization function.

2. Discussion of Prior Art

The operator interface panels are also known as Touch Panels, Touch Screens, Man Machine Interfaces (MMI) and Human Machine Interfaces (HMI). The panels work with one or more, machine or process controllers, and allow users to interact with the controllers by visualizing machine/process status in a variety of forms, and by inputting information, such as setup data, in controllers. The discussion in this document excludes software-based HMIs that run on a PC or a general-purpose computer. This document covers electronic operator interface panels with a dedicated microprocessor.

For the purpose of this document, an operator interface panel is considered to be online when it is performing its intended interface or visualization function. Thus, for our purpose the panel is online when it is displaying programmed video pages and allowing operators to interact with it. In this state, the panel may or may not be connected and communicating to the controller.

In many cases, the Electronic Operator Interface Panels replace much of the hardwired control components from an automation panel, such as Push Buttons, Indicator Lights, Pilot Lights, Meters, etc. The recent trend in industrial automation shows an increased use of panels. The reasons for this trend are:

1. Panels save premium panel space.

2. Panels are cost effective alternative to hardwired control components.

3. Automation panels using Panels can easily be reconfigured as compared to the ones using hardwired controls.

4. Control components can easily be added or deleted from operator interface panel video pages as compared to adding/deleting hardwired components from the hard-wired panel.

5. Operator interface panels offer much more than push buttons and pilot lights. For example, the modem panels will allow you to use Bar graphs, Trend Graphs, Alarm capabilities, etc., on video pages.

Video Pages or screens for a panel are designed using a programming device, typically a PC, running a page-design software specific to the panel. The PC during the page design & development may not be connected to the panel, and does not communicate with the panel. Once all the video pages are designed, PC establishes communication with the operator interface panel and these designed-pages are written to the panel. Then video pages are debugged. If any problem is found, or a change is required, the pages are modified on the PC and the whole program (i.e. all the pages and some other parameters), including the modified pages, are loaded again to the panel. Most panels do not allow for only selected pages to be written to panel. So, even the simplest modification, say correction of a misspelled word, requires the whole program to be written again to panels. When all the video pages or the whole program is written to a panel, the panel stops it's normal visualization function until the whole program is received in the panel, initialized and started, i.e. during the transfer of whole program to the panel, the panel does not remain online.

Most panels also do not allow designing of video pages directly in panels. One has to design the video pages using a programming device (typically a PC) and save them in programming device, and then transfer to the panel.

One of the operator interface panel products, PGI100 with its uWin software from Uticor Technologies allowed users to edit a video page while the PGI100 performed its visualization function, i.e. when it was online. PGI100 however allowed users to edit only one page at a time. User could not view multiple pages & therefore could not cut/copy paste between programmed pages. In addition, the user could not save the video pages from the PGI100 to a PC while in online programming mode. Also, if a user modified a currently displayed video page and saved the modified page to the PGI100, the saved page was not updated automatically on the PGI100 display. User would have to specially update the displayed page to reflect the changes.

This invention allows users to program the panel online with much more flexibility. For the purpose of this document online programming of Panel is defined as ability to create/edit video pages in panel while it is performing it's intended visualization or interface function including, if connected, communication to one or more controllers.

Objects and Advantages

The objects and advantages of this invention are as follows:

1. To provide means to edit video pages in an operator interface panel online, that is, to modify already programmed objects on the pages.

2. To provide means to add or delete video pages directly in the panel without having to go through design on PC and then transfer the whole program

3. To provide means to add or delete objects, such as Push buttons, numeric displays, etc., quickly while the panel is online, without having to add these in a PC file and transfer the whole file to the panel, which is very useful for machine startup and diagnostics.

4. To provide means to view and edit multiple video pages in a panel on a PC while the panel is online.

5. To provide means to cut/copy and paste one or more objects from one video page to another, while the panel is online, without having to make these changes on the file in a PC, and to transfer this file to the panel.

6. To provide means to update a currently displayed page on the panel after it has been edited online.

7. To provide means of saving the pages from panel to PC while the panel is online.

### SUMMARY

The invention allows users to program operator interface panel online with much more flexibility, and as a result save page development time as well as time during machine startup and diagnostics.

With this invention, programming offline (on PC without connecting to the panel) and online (PC connected to the panel, and panel possibly communicating with controller) is practically the same. The invention allows users, while panel is online, to

1. Edit video pages in panel.

2. Design video pages directly within the panel.

3. Add/delete objects to pages for temporary use, such as for startup and diagnostics

4. View multiple pages, programmed in panel, simultaneously, on a PC,

5. Cut/copy and paste objects from one video page to the other, and save to panel,

6. Save the video pages on PC while panel is online

7. Automatically update the displayed page after the page has been modified on line.

This invention saves screen design and development time, and machine/process start-up time, since the changes can be done without going through the usual time-consuming design-download-debug cycle. During machine start up and for diagnostics, temporary objects can quickly be placed and then removed on the pages without going through the time-consuming design-download-debug cycle.

### DRAWINGS

FIG. 1—Block diagram of a system involving an operator interface panel or HMI

FIG. 2—shows typical steps in designing and downloading video pages to panel

FIG. 3—illustrates the concept of “online programming”

FIG. 4—illustrates the online programming of panel with multiple video pages open simultaneously

FIG. 5—illustrates a flow chart of page design software as it relates to the on-line programming

FIG. 6—shows Memory organization for storing video pages within the panel.

FIG. 7—shows how an edited video page is stored in the memory

FIG. 8—shows how a video page is deleted from the memory of panel

FIG. 9—shows how a new video page is added in panel memory

### DESCRIPTIONS

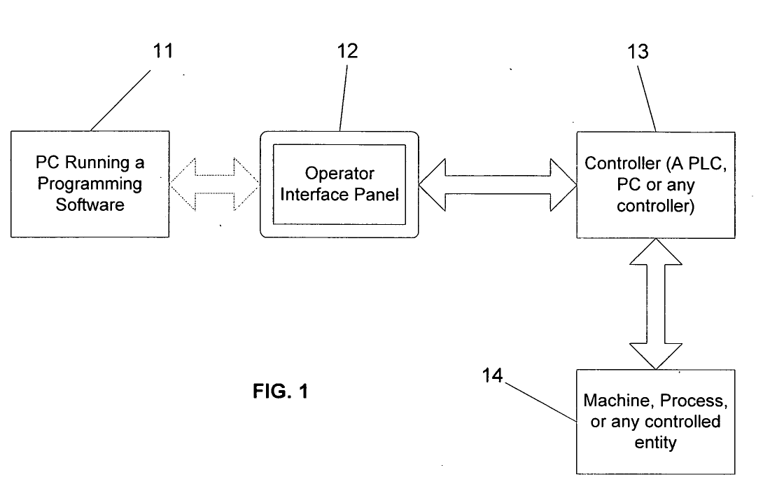

FIG. 1 shows a typical system in block diagram form illustrating the use of an operator interface panel. It shows a PC 11, a panel 12, a controller 13, and a controlled entity 13.

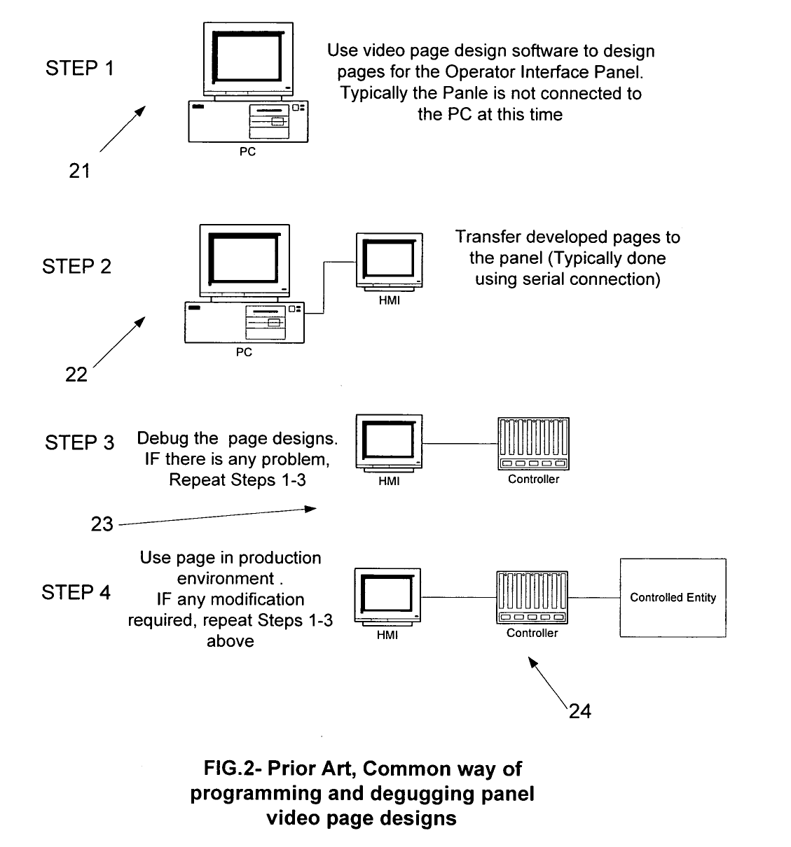

FIG. 2 illustrates typical steps in designing the video pages. In STEP 1 a PC running a page design software is used to design video pages (21). Objects representing typical control components are placed on the pages. The objects are associated with the controller memory variables. Typically the panel is not connected to the PC at this time. In Step 2, the designed-pages are downloaded to the panel (22). Typically the panel is not online at this time i.e. the panel is not performing it's normal function. In STEP 3, the video pages are debugged with controller and panel (23). If any problems are found, then STEP 1 and 2 are repeated to fix the problem. Once the debugging is complete the panel is used in production environment (24)(STEP 4).

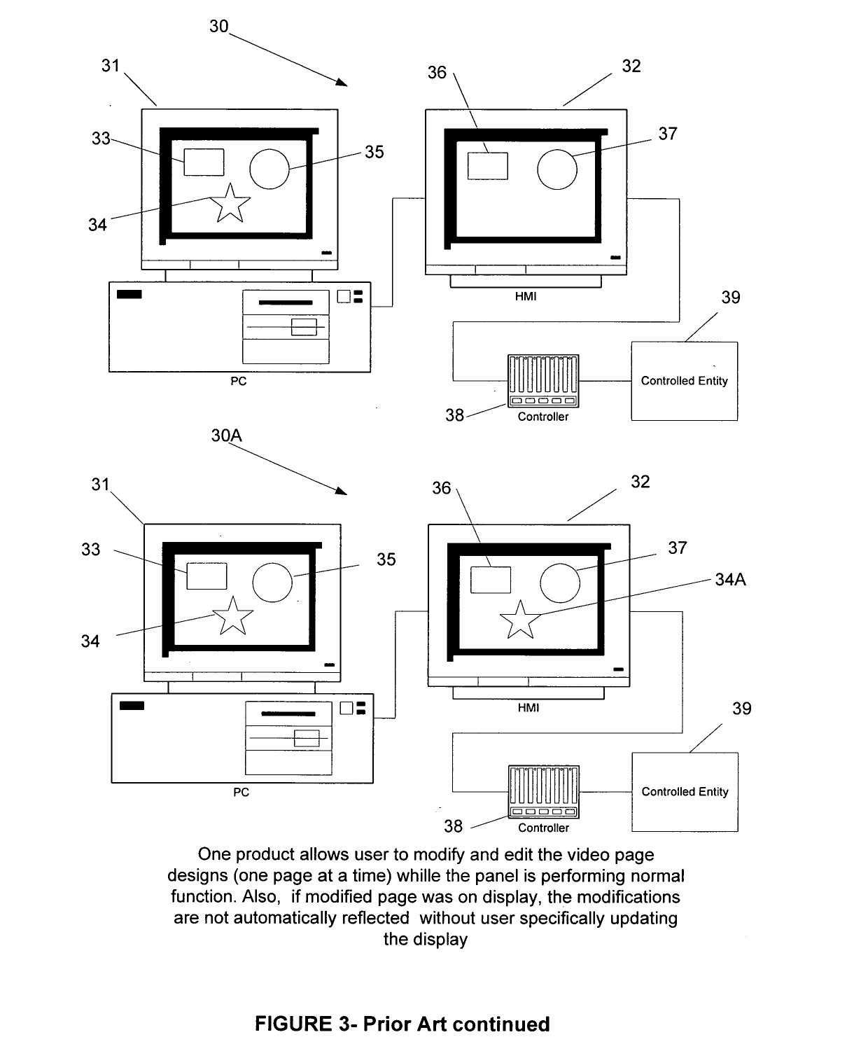

FIG. 3 illustrates the concept of online programming, i.e. the programming of panel while the panel is responding to operator's interactions, and updating the video pages with current values and may be communicating with the controller. In other words, the panel is performing its normal visualization or interface function.

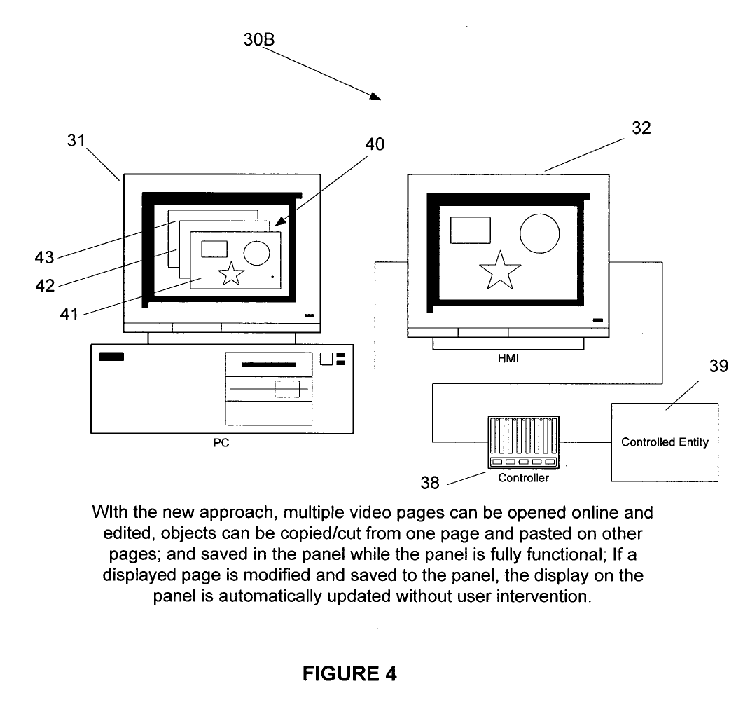

FIG. 4 shows a diagram depicting the same group as shown in FIG. 3, except here user can open multiple video pages on the PC 31 (40, 41, 42, 43) while connected with the online panel 32.

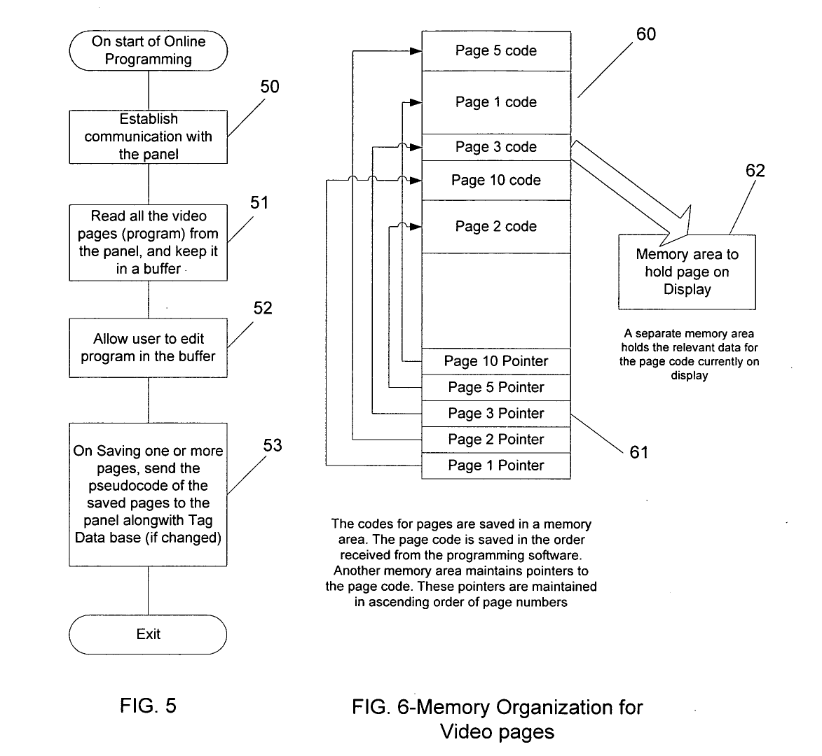

FIG. 5 shows relevant portion of programming software flowchart as it relates to the online programming.

FIG. 6 shows memory organization for storing video page code. The code for each video page is saved in the order it was received from the page design software. The pointers to each page code is saved in another area of memory.

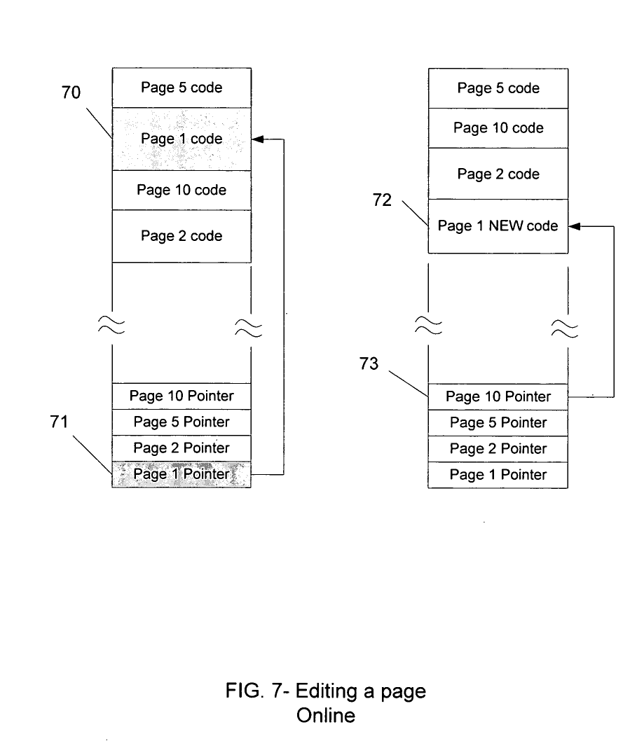

FIG. 7 shows the page memory during the editing process. It shows the memory map during editing of a page.

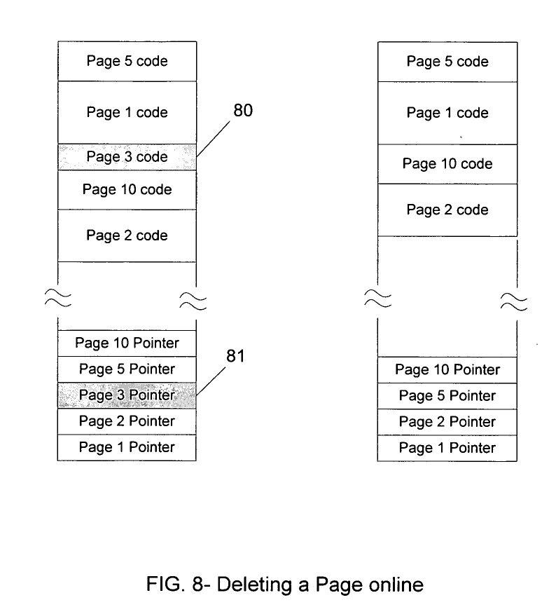

FIG. 8 shows the sequence of steps taken by firmware to delete a video page. It shows the memory map before and after deletion.

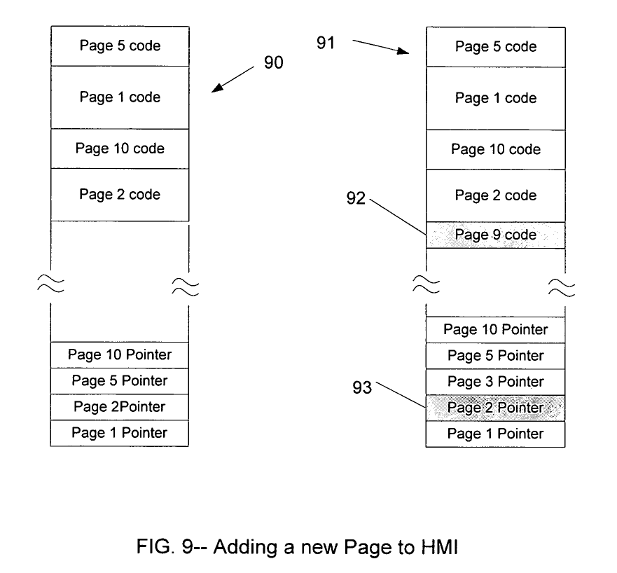

FIG. 9 shows video page memory map during the addition of a new page.

Included is also a CD that has computer readable page design software & firmware of a panel.

### Operation

The online programming allows a user to edit, add, delete, or modify video pages in an operator interface panel while the panel is online, i.e. while the panel is performing its normal operation, which is, the panel is responding to operator touches, updating the displayed pages with latest values, and may be communicating to read/write controller memory,

The online programming introduced in the invention allows users to practically do everything that they can do offline as far as the editing of the video pages is concerned. The users can add new pages, rename pages, delete pages, move objects around, add new objects on a page, delete objects, and so on. The editor ensures that the changes can be saved to the panel without interrupting its operation. In addition the pages can be saved on the PC if the user so desires.

The online programming is very useful to make minor adjustments to video pages, to add a few objects temporarily (for example for diagnostics), correct spelling errors, change colors, etc. The online programming saves time, as the user does not have to go through the design-download-debug cycle. In addition the design & development is quicker as the developer can see the results instantaneously.

A PC 11 is used as a development system for the page design for panel 12. The panel 12 allows user to interact with controller 13 using the objects on the video pages. Controller 13 controls the controlled entity 14, which can be a machine, a process or any other thing.

Typically users will follow the steps outlined in FIG. 2 for developing video pages for an operator interface panel. It is a “design 21-download 22-debug 23” cycle before release for use in a production environment 24. (Download is used here to indicate transferring of designed video pages from PC to panel).

FIG. 3 illustrates the online programming of the panel. Group 30 shows PC 31, Panel 32, Controller 38 and Controlled-entity 39, all connected and communicating with each other. PC 31 and panel 32 both are displaying the same video page, except a new object 34 has been added to the page on PC. Group 30A shows the same items, except it shows that the item 34 on PC 31 screen has been transferred to the display on panel 32, 34A. This transfer took place without affecting the normal function of the panel. That is the panel remained connected and online with the controller. In earlier product (PGI 100 from Uticor) the displayed page is not automatically updated. The invention makes the updating of the page automatic as soon as the new page is saved.

FIG. 4 shows a diagram depicting the same group as shown in FIG. 3, except here user can open multiple video pages on the PC 31 (40, 41, 42, 43) while connected online with the panel 32. User can cut/copy the objects from one page and paste these on other pages, while the panel is online with controller (i.e. panel is doing its normal function). The pages can also be saved on the PC without getting offline.

FIG. 5 shows a flow chart for the relevant portion of video page design software. When user selects the “Online-programming mode”, the page design software running on a PC establishes a communication link with the panel connected to PC. After establishing the connection, the page design software would read all the page-designs from the panel. These page designs are kept in buffers on PC. Users are then allowed to view/edit or add/delete any of these video pages. They are allowed to view more than one page at a time, cut-copy-paste between pages, and save all the pages locally to the PC. In the panel, the pages are stored in a memory area. The video pages are represented by codes in the memory, each page taking up variable number of bytes based on the number of objects, and the types of objects on the page. The pages in memory are saved in the order received from the PC. As shown in FIG. 6, pages are saved in the order of page number 5, 1, 3, 10, and 2 (see 60 in FIG. 6). Another area of memory is used to store pointers to these pages. The pointers, unlike pages, are always kept in ascending order of page numbers (see 61 in FIG. 6). The relevant data of currently displayed page is copied in another memory area (62).

FIG. 7 shows the process of saving an edited video page. Assume that the user edits page 1 (70 in FIG. 7). The pointer 71 is pointing to the area that stores page 1 code. When page design software sends an edited new page 1, it is saved after all pages in memory, the old page code for page 1 is deleted, and the memory is compacted to eliminate gaps. If this was the page on display at this time, the relevant display data of this page is copied in display memory area, and the display is updated to reflect the changes. If the page was not on display, nothing has to be done.

FIG. 8 shows the process of deleting a page from memory. Here the page 3 (80) is being deleted along with its pointer (81). Basically the memory is compacted and the area occupied by page & pointer to be deleted is overwritten.

FIG. 9 shows the process of adding a new page to the panel. In this figure, 90 shows the memory map before adding the page. 91 shows the map after the page 9 (92) has been added. Please note that the page code has been added at the end of all page storage; while the pointer is stored at the appropriate area to keep all pointers in ascending order of video page number.

Included CD has a page design software, called PowerPanel Programming software. The software runs on a PC running Windows 98, NT, 2000 or XP operating system with at least 800×600 screen resolution. To install the software follow the instructions given below:

1. The CD has an auto run feature, i.e. once you insert the CD, it would automatically run the setup program to install the page design software. Follow on screen instructions to install the software.

2. If for any reason, the CD does not auto run, please explore the CD, Find Setup.exe file and run it. Follow on screen instruction to complete the installation.

To experience, the online programming feature the software has to be used along with one of Uticor's Power Panels. After connecting required programming cable between the PowerPanel, and PC, select the online mode from the PowerPanel Editor. The Editor will read the user program from the panel and display the pages from the panel. Navigate through the software to experience the Online-programming feature described here.

We claim:

1. An operator interface panel, with means to electrically connect to a machine controller and with means to electrically connect to a programming device, having multiple video pages with objects that provide operator input to the machine and/or machine status to the operator, having means to open and edit said multiple pages at the same time within said programming device, without interrupting the operation of the interface panel.

2. The Operator interface panel of claim 1 having means to display said video pages on a graphical display comprising of a liquid crystal display or a plasma display or a cathode ray tube.

3. The Operator interface panel of claim 2 having electrical and mechanical means to connect a touch screen to the said graphical display, said touch screen allowing operator input to the machine by touching said objects.

4. An operator interface panel, with means to electrically connect to a machine controller and with means to electrically connect to a programming device, having multiple video pages with objects that provide operator input to the machine and/or machine status to the operator, having means to open and edit said multiple pages at the same time within said programming device, while said video pages continue to provide operator input to the machine and machine status to the operator, and the machine controller continues to control operation of the machine.

5. The Operator interface panel of claim 4 having means to display said video pages on a graphical display comprising of a liquid crystal display or a plasma display or a cathode ray tube.

6. The Operator interface panel of claim 5 having electrical and mechanical means to connect a touch screen to the said graphical display, said touch screen allowing operator input to the machine by touching said objects.

7. An operator interface panel, with means to electrically connect to a machine controller and with means to electrically connect to a programming device, having multiple video pages with objects that provide operator input to the machine and/or machine status to the operator, having means to edit said video pages and having means to automatically update currently displayed video page during said edit without interrupting the operation of panel.

8. The Operator interface panel of claim 7 having means to display said video pages on a graphical display comprising of a liquid crystal display or a plasma display or a cathode ray tube.

9. The Operator interface panel of claim 8 having electrical and mechanical means to connect a touch screen to the said graphical display, said touch screen allowing operator input to the machine by touching said objects.

10. An operator interface panel, with means to electrically connect to a machine controller and with means to electrically connect to a programming device, having multiple video pages with objects that provide operator input to the machine and/or machine status to the operator, having means to edit said video pages and having means to automatically update currently displayed video page during said edit while said video pages continue to provide operator input to the machine and machine status operator, and the machine controller continues to control operation of machine.

11. The Operator interface panel of claim 10 having means to display said video pages on a graphical display comprising of a liquid crystal display or a plasma display or a cathode ray tube.

12. The Operator interface panel of claim 11 having electrical and mechanical means to connect a touch screen to the said graphical display, said touch screen allowing operator input to the machine by touching said objects.

13. An operator interface panel, with means to electrically connect to a machine controller and with means to electrically connect to a programming device, having multiple video pages with objects that provide operator input to the machine and/or machine status to the operator, having means to edit said video pages and having means to save said video pages on a PC, without interrupting the operation of panel.

14. The Operator interface panel of claim 13 having means to display said video pages on a graphical display comprising of a liquid crystal display or a plasma display or a cathode ray tube.

15. The Operator interface panel of claim 14 having electrical and mechanical means to connect a touch screen to the said graphical display, said touch screen allowing operator input to the machine by touching said objects.

16. An operator interface panel, with means to electrically connect to a machine controller and with means to electrically connect to a programming device, having multiple video pages with objects that provide operator input to the machine and/or machine status to the operator, having means to edit said video pages and having means to save said video pages on a PC, while said video pages continue to provide operator input to the machine and machine status operator, and the machine controller continues to control operation of machine.

17. The Operator interface panel of claim 16 having means to display said video pages on a graphical display comprising of a liquid crystal display or a plasma display or a cathode ray tube.

18. The Operator interface panel of claim 17 having electrical and mechanical means to connect a touch screen to the said graphical display, said touch screen allowing operator input to the machine by touching said objects.

19. An electronic operator interface panel with a dedicated microprocessor, with means to electrically connect to a machine controller and with means to electrically connect to a programming device, having multiple video pages with objects that provide operator input to the machine and/or machine status to the operator, having means to open and edit said multiple pages at the same time within said programming device, without interrupting the operation of the interface panel.

20. The Operator interface panel of claim 19 having means to display said video pages on a graphical display comprising of a liquid crystal display or a plasma display or a cathode ray tube.

21. The Operator interface panel of claim 20 having electrical and mechanical means to connect a touch screen to the said graphical display, said touch screen allowing operator input to the machine by touching said objects.

22. An electronic operator interface panel with a dedicated microprocessor, with means to electrically connect to a machine controller and with means to electrically connect to a programming device, having multiple video pages with objects that provide operator input to the machine and/or machine status to the operator, having means to open and edit said multiple pages at the same time within said programming device, while said video pages continue to provide operator input to the machine and machine status to the operator, and the machine controller continues to control operation of the machine.

23. The Operator interface panel of claim 22 having means to display said video pages on a graphical display comprising of a liquid crystal display or a plasma display or a cathode ray tube.

24. The Operator interface panel of claim 23 having electrical and mechanical means to connect a touch screen to the said graphical display, said touch screen allowing operator input to the machine by touching said objects

25. A Method for editing multiple video pages on an operator interface panel, comprising
a. Providing a graphical display to display said video pages,
b. Providing a programming device with means to connect to said operator interface panel,
c. Reading video pages from said operator interface panel to said programming device,
d. Editing said video pages including creation and deletion of video pages,
e. Writing said edited video pages back to said operator interface panel without interrupting the normal function of the panel
Whereby allowing quick changes to video pages saving video page development time as well as machine start-up and diagnostic time.
